(19) United States
(12) Patent Application Publication
(10) Pub. No.: US 2007/0220425 A1
(43) Pub. Date: Sep. 20, 2007

(54) ELECTRONIC MAIL EDITING DEVICE, IMAGE FORMING APPARATUS, AND ELECTRONIC MAIL EDITING METHOD

(76) Inventor: Fabrice Matulic, Tokyo (JP)

Correspondence Address: DICKSTEIN SHAPIRO LLP, 1825 EYE STREET NW, Washington, DC, 20006-5403, US

(21) Appl. No.: 11/673,036

(22) Filed: Feb. 9, 2007

(30) Foreign Application Priority Data
Mar. 14, 2006 (JP) 2006-069881

(51) Int. Cl. G06F 17/00; G06F 15/16; G06F 3/048

(52) U.S. Cl. 715/530; 709/206; 715/781

(57) ABSTRACT

In an electronic mail editing device, an analyzing unit analyzes attribute of input data to extract data elements. A display unit displays an input window in which the original input data is displayed and an email window used for creating email from the input data. In response to an edit command and various setting parameters input through the input window on the display unit, an editing unit edits the input data according to the setting parameters. A display control unit displays the edited data in the email window, and a communicating unit transmits the data via email.

### CROSS-REFERENCE TO RELATED APPLICATIONS

The present document incorporates by reference the entire contents of Japanese priority document, 2006-069881 filed in Japan on Mar. 14, 2006.

### BACKGROUND OF THE INVENTION

1. Field of the Invention

The present invention relates to an electronic mail editing device, an image forming apparatus, and an electronic mail editing method.

2. Description of the Related Art

In an image forming apparatus such as a Multifunction Product (MFP), after a document is read by a scanner, a user has been required to perform editing including addition of some information or writing of a delete mark onto the original document if necessary, and then transmit the edited document by reading it again by a scanner. Accordingly, reading by the scanner has been required at least twice, which poses a problem of bothersome tasks.

To solve this problem, Japanese Patent Application Laid-Open No. 2005-6079 discloses a technology in which the original data and other data, for example, data obtained by editing or correcting the original data, are managed in layers as separate sets of data, and are transmitted via electronic mail (hereinafter, “email”).

According to the conventional technology, the original data edited by, for example, manually adding notes therein, is again scanned. The original and edited data are managed in layers to be transmitted, and the original and edited data are reproduced at the receiving side. However, even with this technology, the manually-edited data has to be again scanned for transmission. That is, the problem of requiring reading by a scanner twice still remains.

### SUMMARY OF THE INVENTION

It is an object of the present invention to at least partially solve the problems in the conventional technology.

According to an aspect of the present invention, an electronic mail editing device includes an analyzing unit that analyzes data and extracts a data element from the data, a display unit that displays an input window in which the data is displayed based on the data element and an edit window used for editing electronic mail, and receives input including a command and a parameter with respect to the data element through the input window, an editing unit that edits the data with respect to the data element based on the input to obtain edited data, and a transmitting unit that transmits electronic-mail contents displayed in the edit window via electronic mail. The display unit displays the edited data in the edit window.

According to another aspect of the present invention, an image forming apparatus includes a reading unit that reads an original and generates data, an electronic mail editing device that receives the data, and creates and transmits electronic mail, and an image forming unit that outputs the data as an image. The electronic mail editing device includes an analyzing unit that analyzes the data and extracts a data element from the data, a display unit that displays an input window in which the data is displayed based on the data element and an edit window used for editing electronic mail, and receives input including a command and a parameter with respect to the data element displayed in the input window, an editing unit that edits the data with respect to the data element based on the input to obtain edited data, and a transmitting unit that transmits electronic-mail contents displayed in the edit window via electronic mail. The display unit displays the edited data in the edit window.

According to still another aspect of the present invention, an electronic mail editing method applied to an electronic mail editing device, includes analyzing data to extract a data element from the data, displaying an input window in which the data is displayed based on the data element and an edit window used for editing electronic mail, receiving input including a command and a parameter with respect to the data element displayed in the input window, editing the data with respect to the data element based on the input to obtain edited data, displaying the edited data in the edit window to create electronic mail, and transmitting the electronic mail.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an image forming apparatus that includes an email editing device according to a first embodiment of the present invention;

FIG. 2 is a functional block diagram of an analyzing unit shown in FIG. 1;

FIG. 3 is a functional block diagram of a block identifying unit shown in FIG. 2;

FIG. 4 is a functional block diagram of a character analyzing unit shown in FIG. 3;

FIGS. 5 and 6 are examples of two display windows displayed on a display unit shown in FIG. 1;

FIG. 7 is a flowchart of an email editing process according to the first embodiment;

FIG. 8 is an example of an email window in an email editing device according to a second embodiment of the present invention;

FIG. 9 is a flowchart of an email editing process according to the second embodiment;

FIG. 10 is a functional block diagram of an image forming apparatus that includes an email editing device according to a third embodiment of the present invention;

FIG. 11 is a schematic for explaining undo and redo operations;

FIG. 12 is a functional block diagram of an email editing device according to a fourth embodiment of the present invention;

FIG. 13 is a schematic for explaining an example of the process of associating data elements together;

FIG. 14 is a functional block diagram of an image forming apparatus that includes an email editing device according to a fifth embodiment of the present invention;

FIG. 15 is a flowchart of an email editing process according to the fifth embodiment; and

FIG. 16 is a block diagram of a hardware configuration of the image forming apparatus according to the embodiments.

### DETAILED DESCRIPTION OF THE PREFERRED EMBODIMENTS

Exemplary embodiments of the present invention are explained in detail below with reference to the accompanying drawings.

An email editing device according to the embodiments is installed thereon an application that includes a module for displaying input data on a display screen and a module for creating email from the data. In response to input of an edit command and various setting parameters from a user, the data is edited based on the setting parameters. The user creates email while viewing the data that he/she is editing. That is, the user can check the contents of the email while editing the email, which facilitates an email editing process.

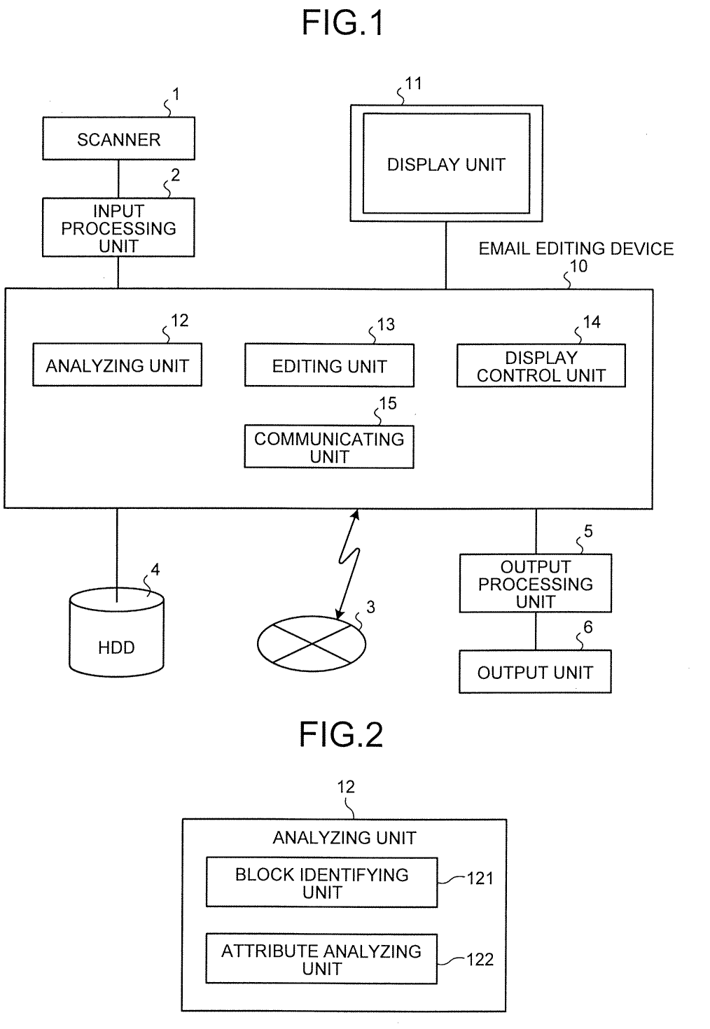

FIG. 1 is a functional block diagram of an image forming apparatus that includes an email editing device according to a first embodiment of the present invention. The image forming apparatus is connected to a network 3, and includes a scanner 1, an input processing unit 2, a storage unit such as a hard disk drive (HDD) 4, an output processing unit 5, an output unit 6, and an email editing device 10. The email editing device 10 includes a display unit 11, an analyzing unit 12, an editing unit 13, a display control unit 14, and a communicating unit 15.

The scanner 1 reads data. The input processing unit 2 converts the analog data read by the scanner 1 to digital data, and then sends the digital data to the email editing device 10. The communicating unit 15 receives data through the network 3. The email editing device 10 receives input of data stored in various recording media through an input unit (not shown).

The HDD 4 stores therein input data and various digital data to be processed. The output processing unit 5 performs output processing on read data. The output unit 6 outputs the data subjected to the output processing by the output processing unit 5.

The email editing device 10 receives electronic data through the scanner 1 or the network 3. The display control unit 14 displays the electronic data on the display unit 11. The display unit 11 receives, through a displayed screen as an interface, input such as an edit command and parameters from the user by touch input or the like. The display unit 11 can be configured as a touch panel having a liquid-crystal display function. The editing unit 13 edits the electronic data based on the edit parameters. The display control unit 14 displays the edited electronic data on the display unit 11 as the contents of email. The communicating unit 15 transmits the displayed contents via email.

The analyzing unit 12 analyzes input data to determine attributes of elements of the data. Examples of the attributes include text, an image, a halftone image, a graph, and a table. The analyzing unit 12 divides the data into blocks according to the attributes. Elements divided into blocks according to the attributes are hereinafter referred to as data elements.

FIG. 2 is a functional block diagram of the analyzing unit 12. The analyzing unit 12 includes a block identifying unit 121 and an attribute analyzing unit 122. The block identifying unit 121 identifies blocks in data. The block identifying unit 121 identifies, for example, each paragraph of text, and an image including a photo image and a table image, and distinguishes the data blocks based on the identification result. The block identifying unit 121 identifies the data blocks by known techniques such as detection of changes in density, detection of an edge portion, and detection of a halftone area.

For example, the block identifying unit 121 identifies a text block by detecting a series of letters or characters, a photographic image block by detecting a cluster of halftone pixels, and a graph or table block by detecting a large difference in density from an edge portion. Otherwise, the block identifying unit 121 determines that the portion is not text, a photographic image, and a graph or table image. These are known techniques, and are not explained in detail.

The attribute analyzing unit 122 analyzes the data blocks identified by the block identifying unit 121 to determine attributes of the respective data blocks as, for example, text, a photographic image, a halftone image, a graph image, and a table image. As a result, the data is divided into blocks according to the attributes. Thus, data elements with respective attributes are obtained.

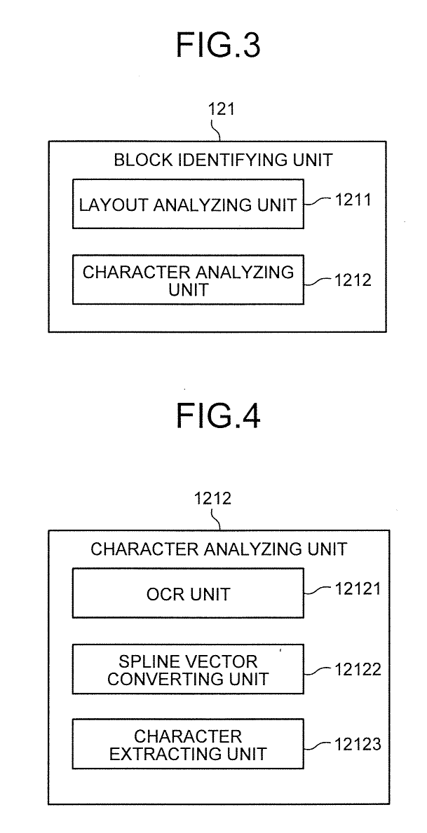

FIG. 3 is a functional block diagram of the block identifying unit 121. The block identifying unit 121 includes a layout analyzing unit 1211 and a character analyzing unit 1212. For a data element extracted by the block identifying unit 121 and the attribute analyzing unit 122, the layout analyzing unit 1211 analyzes its layout structure in the data. Layout analysis performed by the layout analyzing unit 1211 are such that detected information obtained through, for example, edge detection, halftone detection, and pixel position detection is applied to a known algorithm to analyze the layout of each block. Alternatively, because the data element has already been extracted, a known algorithm can be applied to layout analysis of the extracted data element. The character analyzing unit 1212 performs a character recognition process on a data element analyzed as having a text attribute.

FIG. 4 is a functional block diagram of the character analyzing unit. The character analyzing unit 1212 converts a character to a machine-processable format. The character analyzing unit 1212 includes an optical character recognition (OCR) unit 12121, a spline vector converting unit 12122, and a character extracting unit 12123.

The character extracting unit 12123 extracts a character through detection of density variations. The spline vector converting unit 12122 applies a spline shaping process to the extracted character. The OCR unit 12121 optically reads a character that has been read as an image for character recognition. The character recognition can be performed by applying a known algorithm.

As just described, the character analyzing unit 1212 converts a character to a machine-processable format, and therefore, the editing unit 13 can perform editing accurately and quickly. With the OCR unit 12121 that extracts a character image as text data, efficient and convenient display and editing can be achieved. Besides, with the spline vector converting unit 12122, a more smooth character display can be achieved. Further, with the character extracting unit 12123, it is possible to accurately extract a character for character recognition.

The analyzing unit 12 can be configured to determine the attribute of each block based on input related to the attribute provided by the user through the display unit 11. For example, when the user determines that a character image analyzed by the analyzing unit 12 and displayed is actually a photographic image and provides input that specifies the image as a photographic image, the determination is accepted. With this, the attribute of each data element, i.e., a block, can be changed or determined by input from the user.

The display control unit 14 displays each data element on the display unit 11 in two display windows including an input window for displaying input data and an email window for creating email from the data.

The display unit 11 receives input through the two display windows when the user provides input of various setting parameters for editing and printing.

The display unit 11 receives touch input by a finger, a stylus pen, or other touch input instruments. The display unit 11 detects and receives input at each position on the display surface, using a known technique, such as a resistive film scheme of detecting changes in resistance by a press from a fingertip or a pen point or an analog capacitive scheme. In the following, touch input, i.e., touching the display unit 11 to provide input, is cited by way of example and without limitation. However, input can be provided through a mouse, a keyboard, and a press buttons or switches.

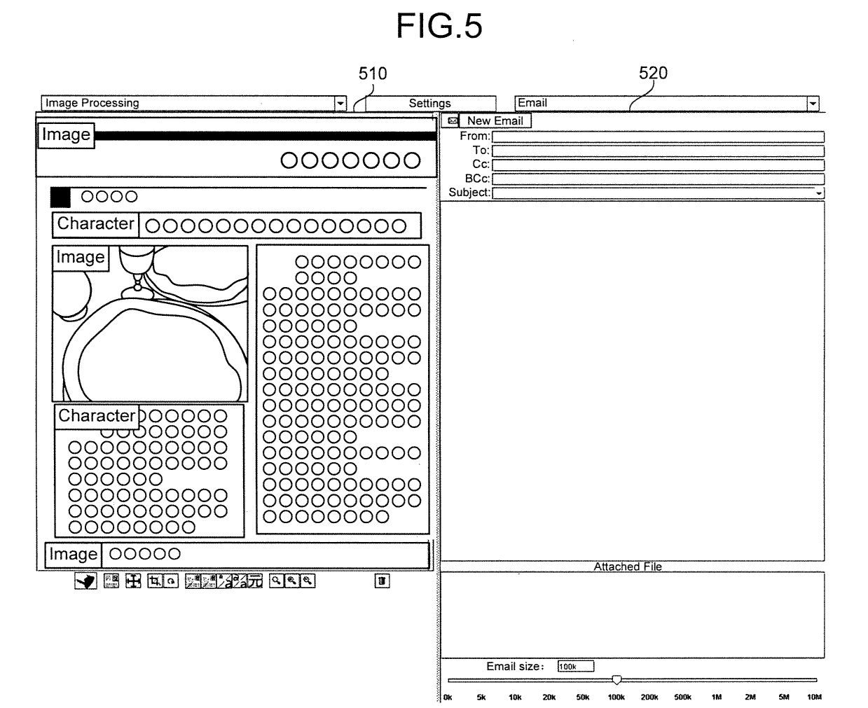

FIG. 5 is an example of two display widows displayed on the display unit 11. In FIG. 5, the display unit 11 displays an input window 510 in which original or unedited input data is displayed and an email window 520. In the input window 510, data is displayed in its original state when read by the scanner 1. The email window 520 is used to create email. FIG. 5 depicts a state in which data is read and displayed on the display unit 11 on which no editing has been performed.

The two display windows each serve as an interface to receive touch input, thereby receiving an edit command or edit input including edit parameters. The editing unit 13 edits the input data based on the edit parameters to create email. The display control unit 14 displays the contents of the email edited by the editing unit 13 in the email window 520 on the display unit 11.

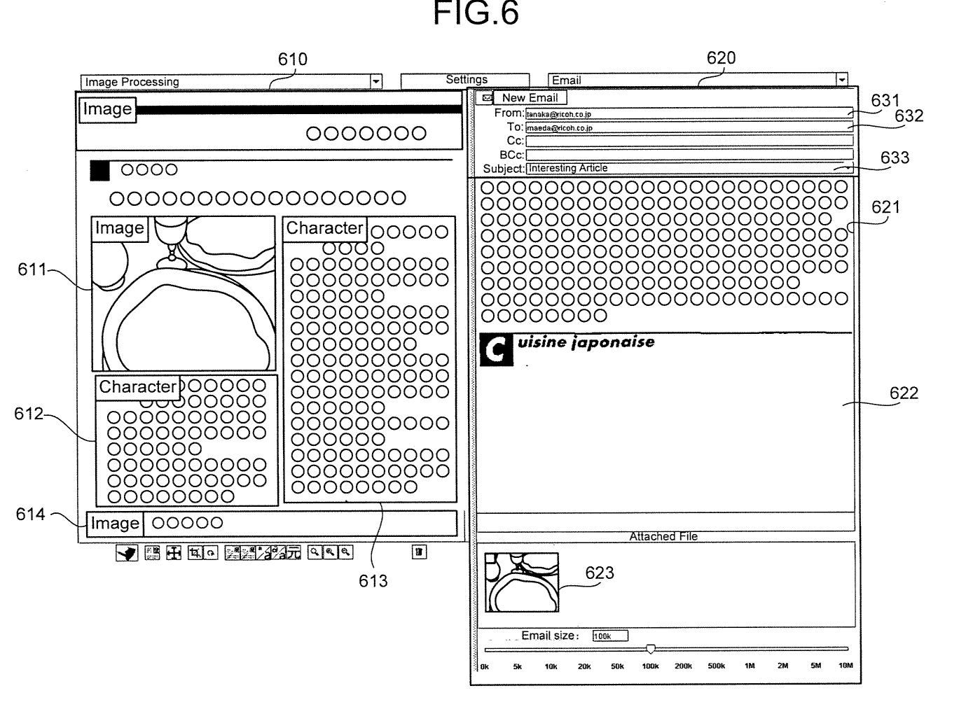

FIG. 6 is another example of the two display windows displayed on the display unit 11. Based on data displayed in an input window 610, email has been created in the email window 620. In the input window 610, a photograph 611, texts 612 and 613, and an image 614 are displayed.

The user drags the photograph 611 in the input window 610 to the email window 620 on the right side and drops it there by, for example, touch input with his/her finger. With this operation, a copy instruction is input through the email window 620.

When the display unit 11 receives the copy instruction, the editing unit 13 copies image data of the photograph 611, and the display control unit 14 displays the image data as an image 623 in the email window 620. In this case, the editing unit 13 can edit the image data in addition to just copying the image data, so that the image data becomes suitable for the email window 620. For example, the amount of information can be reduced to match the email capacity. The photographic image 623 can be created as a thumb nail image for display, and the thumb nail image can be used as an icon of the relevant image. Also, the actual image data can be attached as an attached file.

Similarly, when the user drags the texts 612 and 613 to the email window 620 and drops them there by touch input, the texts 612 and 613 are inserted in a text section 621 of the email window 620. In this case, preferably, the texts 612 and 613 are inserted in the text section 621 as text data already subjected to character recognition instead of character image data.

The display control unit 14 stores in the HDD 4 each data element, which has been obtained by the analyzing unit 12, displayed in the input window 610 and that displayed in the email window 620 after editing in an associated manner. With this, corresponding base data in the input window 610 can be edited depending on edit input through the email window 620.

The display unit 11 divides the data into data elements based on their attributes analyzed by the analyzing unit 12 and, as shown in FIG. 6, displays the data elements in two display windows. Through the display windows on the display unit 11, the user provides input of setting parameters. In other words, the user can provide edit input through both the input window 610 and the email window 620.

In the email window 620, information for a sender section 631, a destination section 632, and a subject section 633 are input from the user through the input function of the display unit 11.

With regard to input for operation through the display unit 11, the user can select an item from a pull-down menu displayed on the display unit 11 by touching the item. The pull-down menu can contain items such as add, move, delete, scaling up/down, and date input.

For example, in the delete operation, a command to delete a data element 622 and the image 623 is received through the email window 620. After the display control unit 14 deletes the data element 622 and the image 623, the data is newly displayed in the email window 620 of the display unit 11.

Apart from touch input by a finger, the user can perform a drag operation on the display unit 11 by a stylus pen or the like for any displayed data element for finer operation. Further, other than the drag operation, a predetermined menu can be displayed on the display unit 11. By touching an item in the displayed menu, a data element can be inserted for display in the email window.

The communicating unit 15 transmits the data edited in the state as displayed in the email window 620 on the display unit 11 via email. With this, the user can edit email while viewing input data on the display unit 11 and send it to a receiver.

Email can take any format, such as an Extensible Markup Language (XML) file, a Hypertext Markup Language (HTML) file, or a text file. Image data can be transmitted as an attached file to the email. For example, an icon of the image 623 is displayed in the email window 620, and the image data file is created and attached to the email. Also, when the character recognition function is low, if text is transmitted as character image data attached to the email, the receiver can compare both the text and the character image data.

The email editing device 10 can send the output processing unit 5 the data edited in the state as displayed in the email window 620 on the display unit 11, and then output the data through the output unit 6. The data edited by the email editing device 10 can be output according to various functions of the image forming apparatus.

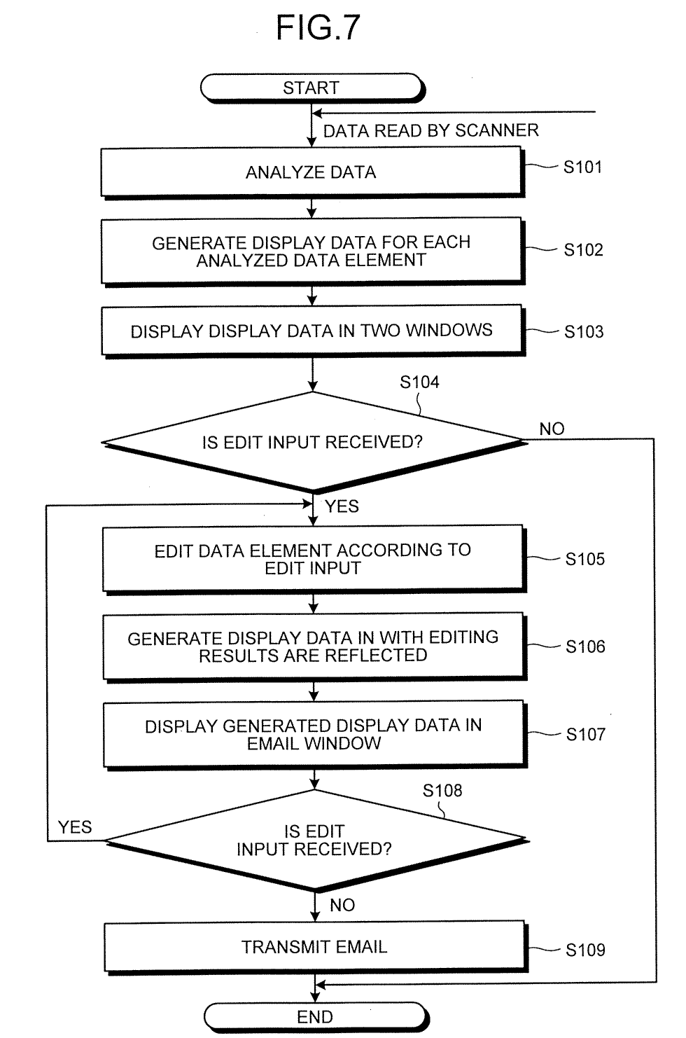

FIG. 7 is a flowchart of an email editing process according to the first embodiment. After the scanner 1 reads data, the input processing unit 2 converts the analog data to digital data, and the digital data is sent to the email editing device 10. The analyzing unit 12 analyzes the data. Specifically, the analyzing unit 12 analyzes the attribute of the data based on the identification of blocks by the block identifying unit 121 and the attribute analysis by the attribute analyzing unit 122, thereby extracting data elements. The layout analyzing unit 1211 and the character analyzing unit 1212 analyze the layout and text data. The character analyzing unit 1212 performs character recognition through an OCR process, a character extracting process, and the like (step S101).

The display control unit 14 generates display data for the input window 510 and the email window 520 for each analyzed data element (step S102). At this stage, however, no input has yet been provided from the user to the email window, and the email window 520 displays an initial screen for creating new email (see FIG. 5).

The display unit 11 displays each data element generated by the display control unit 14 in two display windows. At this time, the input window 510 and the email window 520 are displayed in parallel. However, if no editing has been performed through an image input, the display in the email window 520 can be identical to that in the input window 510. At this time, the editing operation by the user deletes unnecessary portions. The data elements displayed in both display windows are associated by the display control unit 14 (step S103).

The display unit 11 detects whether the user has provided edit input by touching the input window (step S104). If edit input has been received (Yes at step S104), the editing unit 13 edits the data with respect to each data element according to the edit input (step S105). If no edit input has been received (No at step S104), the process ends.

The display control unit 14 associates the edited data elements with the data elements displayed in the input window, and generates display data in the email window 620 (step S106).

The display unit 11 displays the display data generated by the display control unit 14 in the email window 620 (step S107). Here, again, the display unit 11 receives edit input from the user by touch input. The email window 620 displays already-edited data, and edit input can be provided through the email window 620 (step S108).

If edit input has been received through any one of the display windows (Yes at step S108), the process returns to step S105. If no edit input has been received (No at step S108), the communicating unit 15 transmits email with the contents displayed in the email window 620 (step S109).

As described above, the email editing device according to the first embodiment is installed thereon an application that includes a module for displaying original input data and a module for creating email from the data. The display unit 11 displays two display windows, i.e., the input window and the email window, by the modules. Through the two types of windows, input such as touch input is provided for editing email. Thus, the user can check the contents of the email while editing the email by a simple operation such as touch input, and transmit it. This increases convenience and efficiency in email editing.

Moreover, with the application of the email editing device to an image forming apparatus, based on data read by the scanner function of the image forming apparatus, the user can create email while viewing an email editing screen, and then transmit the email. Therefore, the image forming apparatus with the email editing device can achieve high operability and facilitate email editing.

The communicating unit 15 can be configured to transmit data read by the scanner 1 as it is as an attached electronic file to email. In this case, the data can be simply read and transmitted without particularly requiring manual email editing.

The display unit 11 preferably displays the input window and the email window in parallel. With parallel display, the user can edit email while comparing the two display windows, and email editing can be facilitated.

The display unit 11 preferably arranges data analyzed by the analyzing unit 12 in two display windows on a data element basis. Also preferably, the display unit 11 receives a request to embed data in an email body displayed in the email window with respect to each data element displayed in the input window. This is suitable in view of a visual aspect and work efficiency, with the elements being displayed and arranged by units of data elements obtained by dividing the data into blocks according to the attributes.

The display unit 11 preferably receives a request for attaching data to email as a file on a basis of a data element displayed in the input window. With this, for example, photographic image data with a large amount of information can be attached as an attached file, which reduces the volume of the email.

When the data elements analyzed by the analyzing unit 12 are displayed on the display unit 11, the display unit 11 preferably displays a block frame indicating a block of each data element or displays each data element as being surrounded by the block frame. Preferably, the block frame is rectangle in shape, because, in general, a document delimits its paragraphs, graphs, tables, images and the like in rectangle regions. With such a block frame, the display control unit 14 can display blocks of text, images, photographs and the like so that the respective blocks can be easily distinguished by the user.

When receiving through the input window requests to insert data elements into data displayed in the email window, the display unit 11 preferably arranges the data elements on the screen in the email window in the order in which the requests were received. The display control unit 14 generates data for display according to the order of the requests, and then displays the data in this order. With this, high operability can be achieved with links between sentences being preserved. Also, arrangement of images and the like can be automatically determined according to the order.

In an email editing device according to a second embodiment of the present invention, the display control unit 14 arranges text data in input data in a text section of the email window, and displays a data element other than the text data as an attached file in an attached file section of the email window. The communicating unit 15 transmits the text data via email with the attached file.

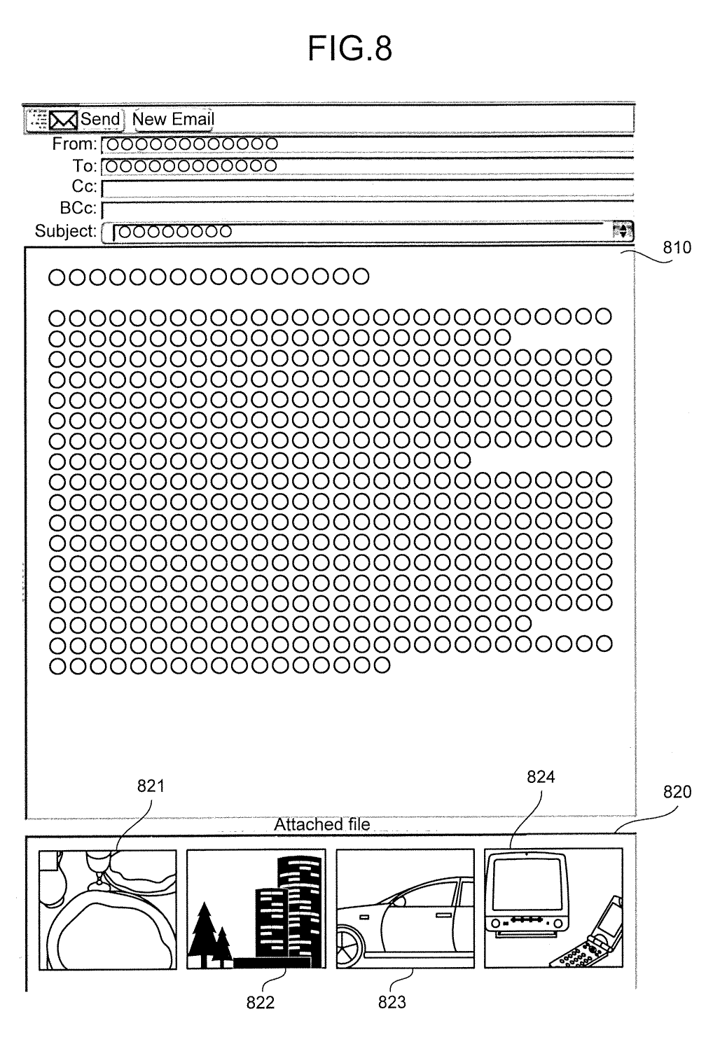

FIG. 8 is an example of the email window in the email editing device according to the second embodiment. In FIG. 8, data analyzed as text by the analyzing unit 12 is automatically arranged in a text section 810 by the display control unit 14.

On the other hand, data analyzed by the analyzing unit 12 as an image is automatically converted into an attached file of image data by the display control unit 14, and is attached to email. Icons 821 to 824 representing image data are displayed in an attached file section 820. As in the first embodiment, the attached file can be manually attached to the email according to edit input provided by the user, rather than automatically attached by the display control unit 14.

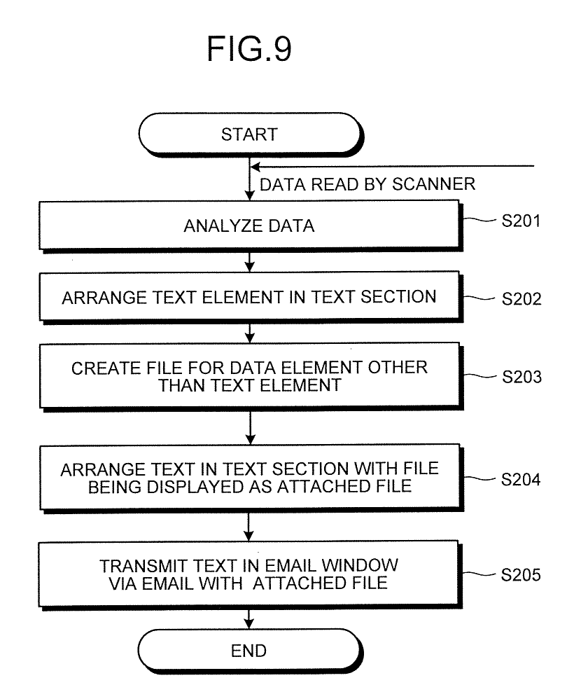

FIG. 9 is a flowchart of an email editing process according to the second embodiment. The analyzing unit 12 analyzes data read by the scanner 1 to extract data elements (step S201). The display control unit 14 arranges a text element of the input data in a text section of the email window (step S202). The display control unit 14 creates an attached file for data elements other than the text element (step S203).

The display control unit 14 arranges text data composed of letters or characters in the text section of the email window with the attached file being displayed in the attached file section (step S204). The communicating unit 15 transmits the text data in the email window via email with the attached file (step S205).

With this configuration, the read data is automatically analyzed to embed text data in email body, and data other than the text data, such as image data, is attached as an attached file to the email. Accordingly, text data not requiring a large capacity is embedded into email body to be quickly recognizable, and image data requiring a large capacity is converted into an attached file that is opened by an application to reduce the required transmission capacity. Consequently, convenience in creating email can be increased, and email volume can be reduced.

The display control unit 14 can attach text data to email as an attached file in a text file format, and indicate the attachment of the text data. By compressing the attached file, email volume can be further reduced.

The display control unit 14 preferably creates an icon for an attached file attached to email and displays the icon in the email window. This makes the attachment of the file visually recognizable, which increasing operability.

The user can input a request to embed data in email body or create an attached file by a single or double click on the display unit 11. With such different types of clicking, different requests can be made to embed data in email and convert data to an attachment file, which increases operability.

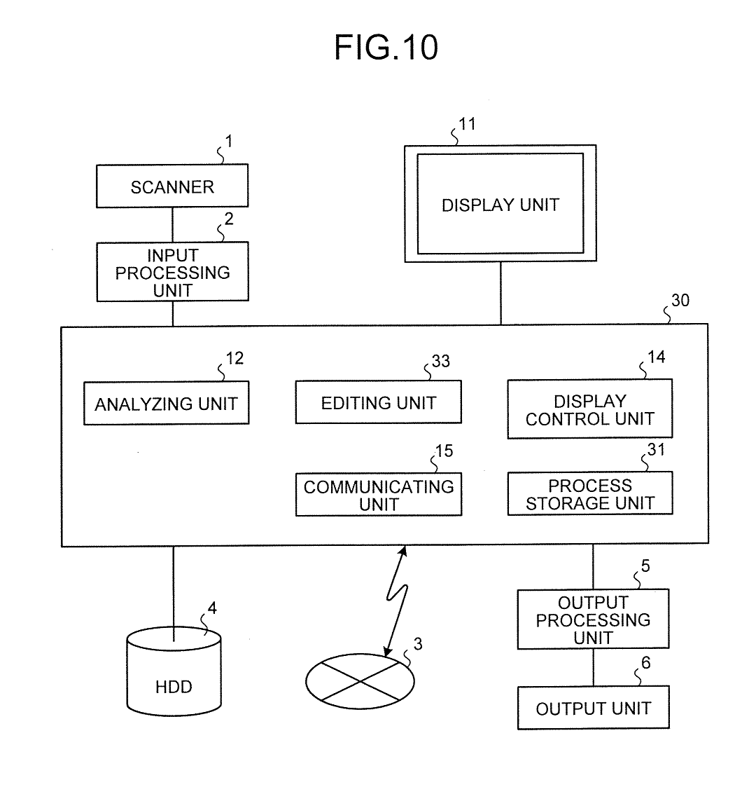

FIG. 10 is a functional block diagram of an email editing device 30 according to the third embodiment. The email editing device 30 is basically similar to the email editing device 10 except that a process storage unit 31 stores therein information on process applied to a data element. Based on the information, an editing unit 33 undoes the last process carried out to restore data in its previous state and redoes the last process carried out.

In response to an undo or redo command input through the display unit 11, the editing unit 33 undoes or redoes the last action based on the information stored in the process storage unit 31. The display control unit 14 displays a result of an undo or redo operation on the display unit 11.

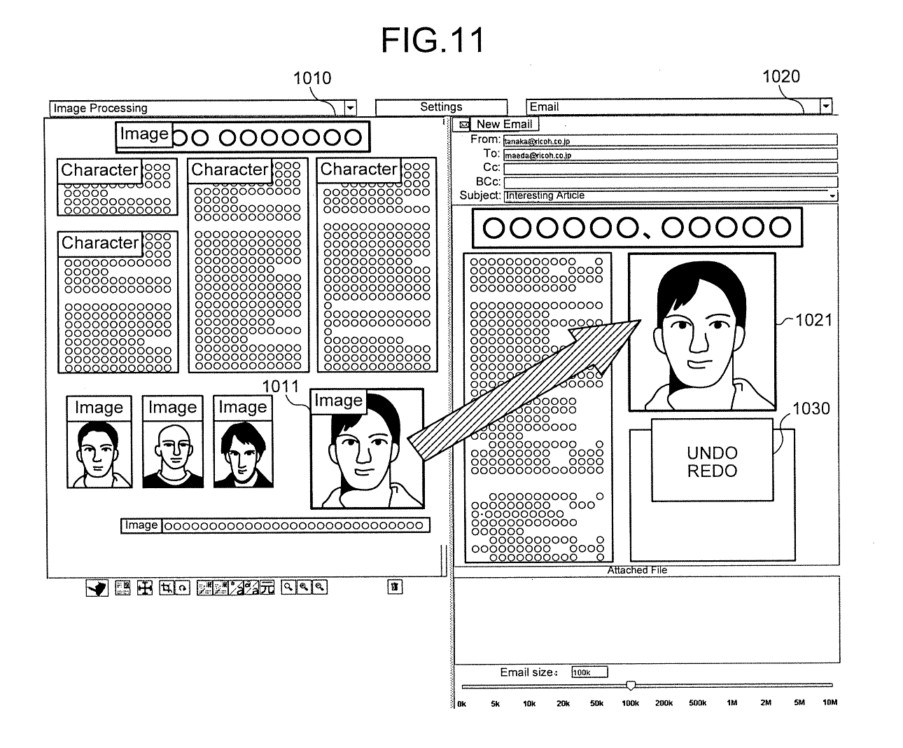

FIG. 11 is a schematic for explaining undo and redo operations. In FIG. 11, an image 1011 in an input window 1010 is dragged by the user to an email window 1020, data of a copied image is generated, and an image 1021 is displayed in the email window 1020. In this state, for example, if the user double-clicks the image 1021, a pull-down menu 1030 for undo and redo appears. The user touches with his/her finger either one of undo and redo items on the pull-down menu 1030 to request an undo or redo operation.

In response to the undo or redo request, the editing unit 33 obtains display data stored in the process storage unit 31. Based on the obtained display data, the display control unit 14 displays resultant data after undo or redo in the email window 1020 on the display unit 11.

With this configuration, a request for an undo or redo operation can be input through the display unit 11. In response to the undo or redo request, the editing unit 33 reads edited data stored in the process storage unit 31. In the email window 1020, resultant data after undo or redo is displayed. Thus, the user can edit email with less operational errors, and convenience and efficiency for the user can be improved.

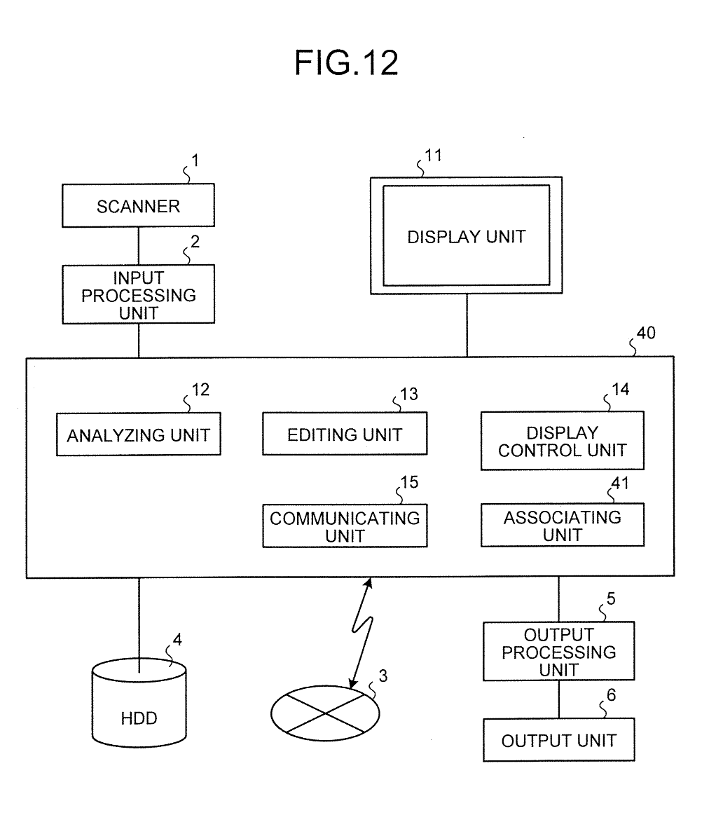

FIG. 12 is a functional block diagram of an email editing device 40 according to the fourth embodiment. The email editing device 40 is basically similar to the email editing device 10 except for the presence of an associating unit 41. The associating unit 41 links or associates data elements analyzed by the analyzing unit 12 together based on the attributes of the data elements.

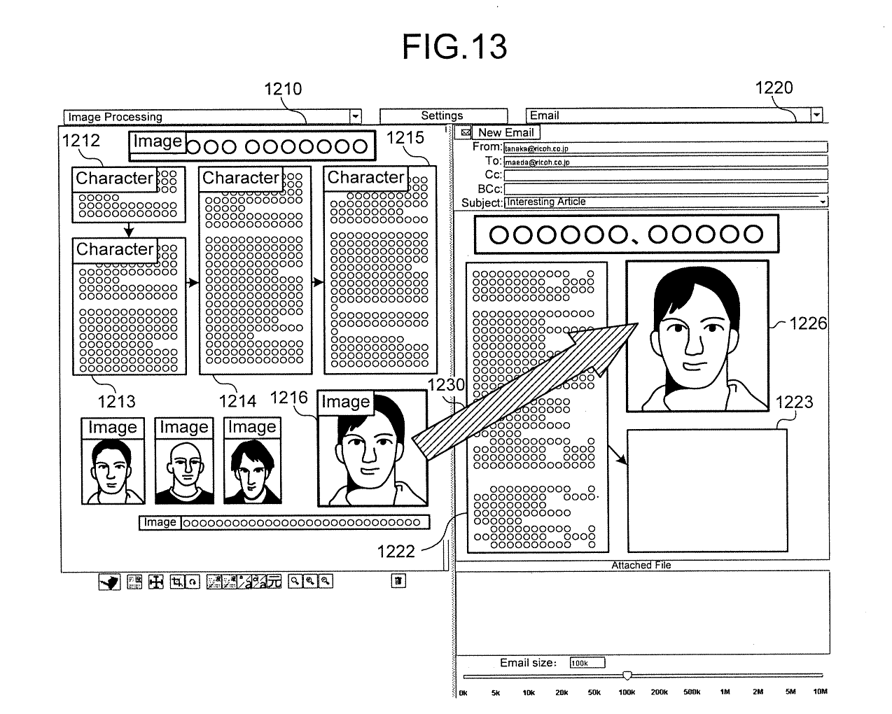

FIG. 13 is a schematic for explaining an example of the process of associating data elements together. In FIG. 13, when the user touches with his/her finger text blocks 1212 to 1215 in this order on the display unit 11, and the associating unit 41 associates the text blocks 1212 to 1215 together in this order.

With such association, for example, when the user drags a set of data elements to an email window 1220 and drops it there to embed the data elements in email body, the display control unit 14 arranges the data elements associated by the associating unit 41 in data blocks 1222 and 1223 in the associated order for display.

Preferably, as shown in FIG. 13, the display unit 11 indicates the association between the data elements by an arrow. By visually recognizing such an arrow, the user can easily recognize the association between the data elements.

The associating unit 41 links or associates the data elements analyzed by the analyzing unit 12 together based on the attributes of the data elements. When the data elements are associated based on the attributes, the user can be aware of the attributes, and an editing task can be facilitated.

Further, the associating unit 41 automatically associates data elements. For example, based on a result of analyzing the description order of data elements and attributes of the data elements analyzed by the attribute analyzing unit 122, the associating unit 41 associates only data elements with the same attribute according to the description order. In such an associated state as having the same attribute, the data elements are displayed by the display control unit 14 on the display unit 11.

With this, upon reading data, only texts or images can be automatically collected, and association between the contents can be visually recognized with ease in creating email. A result of arranging data elements automatically associated in the order can be displayed as, for example, the data blocks 1222 and 1223 in FIG. 13.

In FIG. 13, an image 1216 in an input window 1210 is displayed as an enlarged image 1226 in the email window 1220 and, as a result of associating the image 1216 with the image 1226 by the associating unit 41, an arrow 1230 representing the association is displayed. With this, for example, divided texts and images are arranged in the email window 1220 while being associated according to the description order, resulting in a display in which the data configuration can be visually recognized with ease.

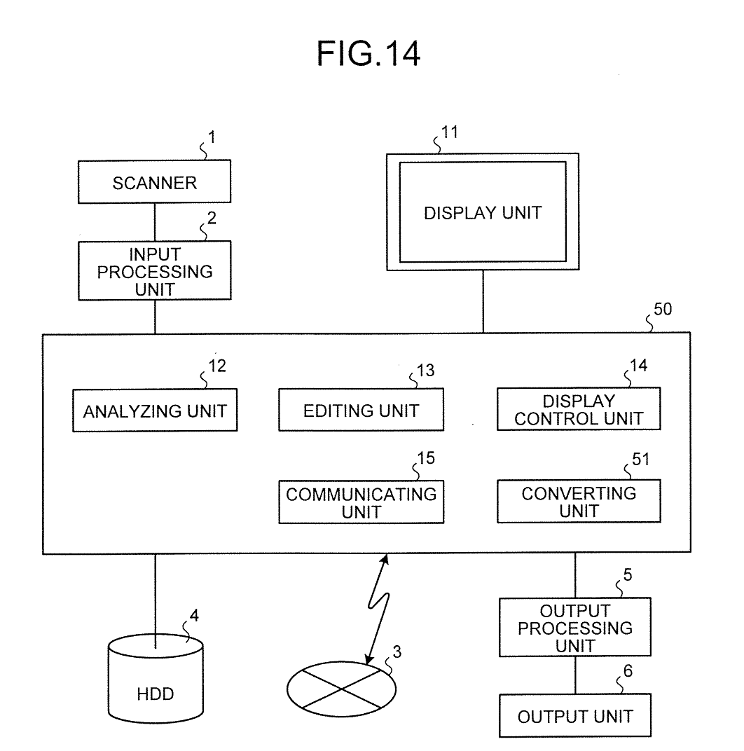

FIG. 14 is a functional block diagram of an email editing device 50 according to the fifth embodiment. The email editing device 50 is basically similar to the email editing device 10 except that email is transmitted in HTML format when an image is embedded in the email while email is transmitted in a text format when the email contains only text.

The email editing device 50 further includes a converting unit 51. When email body displayed in the email window contains an image, the email is converted to HTML format. The communicating unit 15 transmits the email in HTML format obtained through conversion by the converting unit 51.

On the other hand, when email body displayed in the email window contains only text data, the converting unit 51 creates email in a text format. The communicating unit 15 transmits the email in the text format created by the converting unit 51.

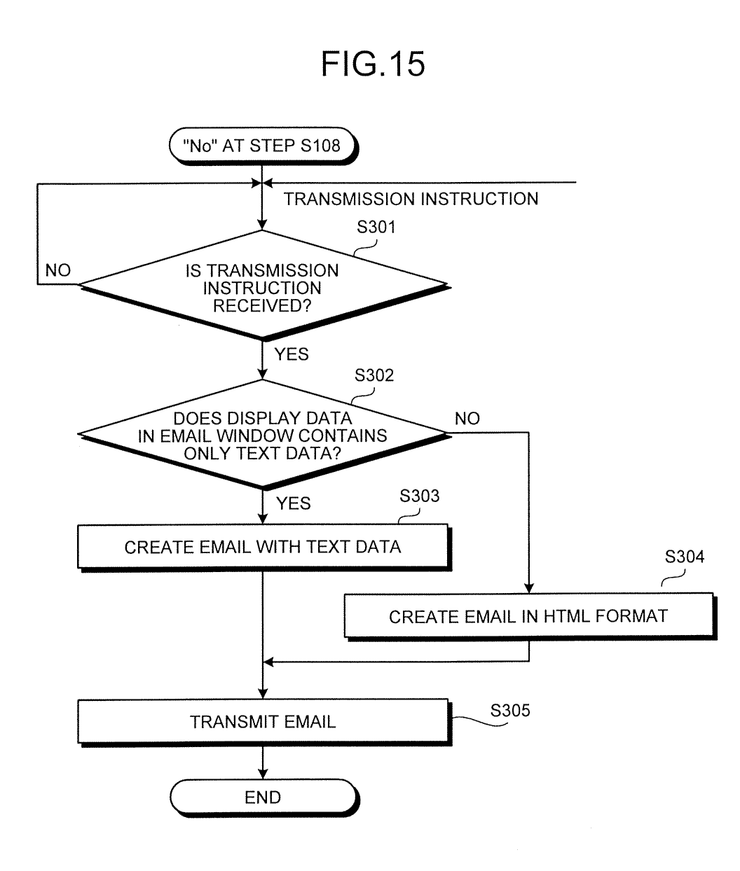

FIG. 15 is a flowchart of an email editing process according to the fifth embodiment. The process up to “No” at step S108 described in the first embodiment in connection with FIG. 7 can be applied to the email editing process of the fifth embodiment, and therefore, steps thereafter are explained. When no further edit input is received (No at step S108), the converting unit 51 waits for receipt of a transmission instruction (step S301). If a transmission instruction is received (Yes at step S301), the converting unit 51 determines whether the display data in the email window contains only text data (step S302).

If the display data contains only text data (Yes at step S302), the converting unit 51 creates email with the text data (step S303). If the display data contains not only text data (No at step S302), the converting unit 51 create email in HTML format (step S304). The communicating unit transmits the created email (step S305).

With this configuration, in the case of transmitting text data only, email with less volume can be transmitted. In the case transmitting data including image data, email can be transmitted as a simple HTML file generally used.

The email editing device 50 can be configured such that the analyzing unit 12 analyzes email address information from data, and the communicating unit 15 writes the email address information to a list of senders and recipients. The list of senders and recipients is automatically created, and therefore, convenience for the user is increased.

Also, the email editing device 50 can be configured such that the analyzing unit 12 analyzes email address information of a destination from the data, and the communicating unit 15 transmits email with contents displayed in the email window to the email address analyzed by the analyzing unit 12. Thus, a transmission destination is automatically determined, which further increases convenience for the user.

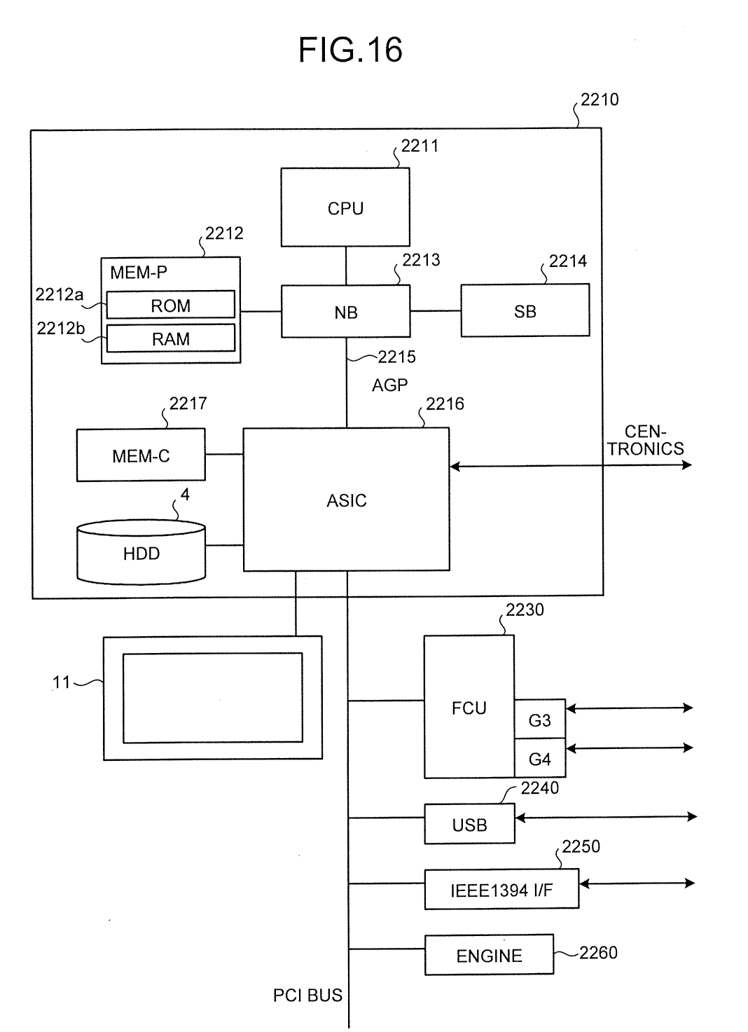

FIG. 16 is a block diagram of a hardware configuration of an image forming apparatus according to the embodiments. The image forming apparatus is configured as an MFP having multiple functions, such as facsimile and scanner functions. The MFP includes a controller 2210 and an engine unit 2260 connected to each other via a peripheral element interconnect (PCI) bus. The controller 2210 is controls the MFP as well as performing various controls including image display control, image processing control and email editing for input from a facsimile control unit (FCU) 2230 and the display unit 11. The engine unit 2260 is, for example, an image processing engine connectable to the PCI bus, and includes, for example, an image processing unit that performs error diffusion, gamma conversion and the like for image data obtained.

The controller 2210 includes a central processing unit (CPU) 2211, a northbridge (NB) 2213, a system memory (MEM-P) 2212, a southbridge (SB) 2214, a local memory (MEM-C) 2217, an application specific integrated circuit (ASIC) 2216, and the HDD 4. The NB 2213 and the ASIC 2216 are connected with an accelerated graphics port (AGP) bus 2215. The MEM-P 2212 includes a read only memory (ROM) 2212a and a random access memory (RAM) 2212b.

The CPU 2211 controls the MFP, and includes a chip set including the NB 2213, the MEM-P 2212, and the SB 2214. The CPU 2211 is connected to other devices via the chip set.

The NB 2213 is a bridge for connecting the CPU 2211 to the MEM-P 2212, the SB 2214, and the AGP 2215. The NB 2213 includes a memory controller that controls, for example, reading/writing from/to the MEM-P 2212, a PCI master, and an AGP target.

The MEM-P 2212 is a system memory used as, for example, a memory for storing programs and data, or a memory into which programs and data are loaded, and includes the ROM 2212a and the RAM 2212b. The ROM 2212a is used to store programs and data, while the RAM 2212b is a writable and readable memory used as, for example, a memory into which programs and data are loaded or an image rendering memory for image processing.

The SB 2214 is a bridge for connecting the NB 2213 to PCI devices and peripheral devices. The SB 2214 is connected to the NB 2213 via the PCI bus. To the PCI bus, the FCU 2230, etc. is also connected.

The ASIC 2216 is an Integrated Circuit (IC) dedicated to multimedia information processing, and includes hardware elements for multimedia information processing. The ASIC 2216 serves as a bridge for connecting the AGP 2215, the PCI bus, the HDD 4, and the MEM-C 2217.

This ASIC 2216 includes a PCI target, an AGP master, an arbiter (ARB) that is a core of the ASIC 2216, a memory controller that controls the MEM-C 2217, and a plurality of Direct Memory Access Controllers (DMACs) for image data rotation, etc by hardware logic or the like. Between the ASIC 2216 and the engine unit 2260, a Universal Serial Bus (USB) 2240, and the Institute of Electrical and Electronics Engineers (IEEE) 1394 interface (I/F) 2250 are connected to the ASIC 2216 via the PCI bus.

The MEM-C 2217 is a local memory for use as an image buffer for transmission or a coding buffer. The HDD 4 stores therein image data, programs, font data, and forms.

The AGP 2215 is a bus interface for a graphics accelerator card suggested for higher-speed graphic processing, and increases the speed of the graphics accelerator card by directly accessing the MEM-P 2212 with a high throughput.

The display unit 11 connected to the ASIC 2216 receives data input from the user, and transmits the input data to the ASIC 2216.

Incidentally, computer programs executed on the MFP according to the embodiments (hereinafter, “email editing program” and “image forming program”) are previously stored in a ROM or the like.

The email editing program and the image forming program can be provided as being recorded, as a file in an installable or executable format, on a computer-readable recording medium, such as a Compact-Disk Read-Only Memory (CD-ROM), a flexible disk (FD), a Compact-Disk Readable (CD-R), or a Digital Versatile Disk (DVD).

The email editing program and image forming program can be stored in a computer connected to a network such as the Internet, and downloaded from the computer through the network. Also, the email editing program and image forming program can be provided or distributed through a network such as the Internet.

The email editing program image forming program include modules that implement the units explained above (the analyzing unit 12, the editing unit 13, the display control unit 14, the communicating unit 15, the associating unit 41, etc.). In hardware, the CPU loads the email editing program and the image forming program from the ROM and executes the programs, thereby implementing the analyzing unit 12, the editing unit 13, the display control unit 14, the communicating unit 15, the associating unit 41, and the like on a main storage.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electronic mail editing device comprising:
an analyzing unit that analyzes data and extracts a data element from the data;
a display unit that displays an input window in which the data is displayed based on the data element and an edit window used for editing electronic mail, and receives input including a command and a parameter with respect to the data element through the input window;
an editing unit that edits the data with respect to the data element based on the input to obtain edited data; and
a transmitting unit that transmits electronic-mail contents displayed in the edit window via electronic mail, wherein
the display unit displays the edited data in the edit window.

2. The electronic mail editing device according to claim 1, wherein the display unit receives the input through the edit window.

3. The electronic mail editing device according to claim 1, wherein the display unit displays the input window and the edit window in parallel.

4. The electronic mail editing device according to claim 1, further comprising a reading unit that reads an original and generates the data.

5. The electronic mail editing device according to claim 1, wherein
the display unit receives a request to attach the data element displayed in the input window to the electronic mail as a file, and
the transmitting unit transmits the electronic mail attached the file.

6. The electronic mail editing device according to claim 1, wherein the display unit displays a block frame indicating a block of the data element.

7. The electronic mail editing device according to claim 6, wherein the block frame is rectangle in shape and surrounds the data element.

8. The electronic mail editing device according claim 1, wherein, upon receiving requests to insert data elements displayed in the input window into the electronic-mail contents displayed in the edit window, the display unit arranges the data elements in the edit window in order in which the requests were received.

9. The electronic mail editing device according to claim 5, wherein the display unit arranges text data in the data in a text section of the edit window based on analysis by the analyzing unit.

10. The electronic mail editing device according to claim 6, wherein the display unit arranges text data in the data in a text section of the edit window based on analysis by the analyzing unit.

11. The electronic mail editing device according to claim 8, wherein the display unit arranges text data in the data in a text section of the edit window based on analysis by the analyzing unit.

12. The electronic mail editing device according to claim 5, wherein
the display unit converts data other than text data in the data to a file attached to the electronic mail based on analysis by the analyzing unit, and indicates attachment of the file in the edit window, and
the transmitting unit transmits the electronic mail attached the file.

13. The electronic mail editing device according to claim 6, wherein
the display unit converts data other than text data in the data to a file attached to the electronic mail based on analysis by the analyzing unit, and indicates attachment of the file in the edit window, and
the transmitting unit transmits the electronic mail attached the file.

14. The electronic mail editing device according to claim 8, wherein
the display unit converts data other than text data in the data to a file attached to the electronic mail based on analysis by the analyzing unit, and indicates attachment of the file in the edit window, and
the transmitting unit transmits the electronic mail attached the file.

15. The electronic mail editing device according to claim 1, wherein the display unit receives, through a drag-and-drop operation, at least any one of a request to insert the data element displayed in the input window into the electronic-mail contents and a request to convert the data element to a file attached to the electronic mail.

16. The electronic mail editing device according to claim 1, wherein
upon determining that the electronic-mail contents include an image, the transmitting unit transmits the electronic mail in hypertext markup language format, and
upon determining that the electronic-mail contents include only text, the transmitting unit transmits the electronic mail in text format.

17. The electronic mail editing device according to claim 1, wherein
the analyzing unit analyzes the data to obtain electronic-mail address information, and
the transmitting unit has a list of senders and recipients of electronic mail, and writes information on a sender and a recipient of the electronic mail to the list based on the electronic-mail address information.

18. An image forming apparatus comprising:
a reading unit that reads an original and generates data;
an electronic mail editing device that receives the data, and creates and transmits electronic mail; and
an image forming unit that outputs the data as an image, wherein
the electronic mail editing device includes
an analyzing unit that analyzes the data and extracts a data element from the data;
a display unit that displays an input window in which the data is displayed based on the data element and an edit window used for editing electronic mail, and receives input including a command and a parameter with respect to the data element displayed in the input window;
an editing unit that edits the data with respect to the data element based on the input to obtain edited data; and
a transmitting unit that transmits electronic-mail contents displayed in the edit window via electronic mail,
the display unit displays the edited data in the edit window.

19. An electronic mail editing method applied to an electronic mail editing device, the electronic mail editing method comprising:
analyzing data to extract a data element from the data;
displaying an input window in which the data is displayed based on the data element and an edit window used for editing electronic mail;
receiving input including a command and a parameter with respect to the data element displayed in the input window;
editing the data with respect to the data element based on the input to obtain edited data;
displaying the edited data in the edit window to create electronic mail; and
transmitting the electronic mail.

20. The electronic mail editing method according to claim 19, wherein the transmitting includes transmitting the data as an electronic file attached to the electronic mail.
